(19) United States
(12) Patent Application Publication
(10) Pub. No.: US 2022/0186839 A1
(43) Pub. Date: Jun. 16, 2022

(54) Magnetic Valve

(71) Applicant: ZHEJIANG DUNAN ARTIFICIAL ENVIRONMENT CO., LTD., Shaoxing, Zhejiang (CN)

(72) Inventors: Shaojun ZHAN, Shaoxing, Zhejiang (CN); Qiubo HE, Shaoxing, Zhejiang (CN)

(21) Appl. No.: 17/439,419

(22) PCT Filed: Mar. 13, 2020
(86) PCT No.: PCT/CN2020/079274

§ 371 Date: Sep. 15, 2021

(30) Foreign Application Priority Data
Mar. 19, 2019 (CN) 201910208918.8

(51) Int. Cl. F16K 1/36; F16K 1/54; F16K 27/02; F16K 31/06; F16K 39/02

(52) U.S. Cl. CPC F16K 1/36; F16K 1/54; F16K 39/02; F16K 31/0651; F16K 31/0655; F16K 27/029

(57) ABSTRACT

Disclosed is a magnetic valve, including: a valve body, provided with an installation cavity, a first valve port and a second valve port; a valve core, installed in the installation cavity and provided with a valve opening position and a valve closing position, a second cavity located at an outer periphery of a main body of the valve core and a third cavity located at a second end of the valve core, the first valve port is communicated with the third cavity and the second valve port is communicated with the second cavity; a core iron assembly, including a core iron, herein the valve core is fixedly connected with a first end of the core iron; an attractor, installed in the installation cavity and located at a second end of the core iron; and a balancing channel, extended along an axial direction of the valve core and the core iron.

### CROSS-REFERENCE TO RELATED DISCLOSURE

The present disclosure claims priority to Patent Disclosure No. 201910208918.8, filed to the China National Intellectual Property Administration on Mar. 19, 2019 and entitled “Magnetic valve”.

### TECHNICAL FIELD

The present disclosure relates to the technical field of control valves, and in particular to a magnetic valve.

### BACKGROUND

Along with the increase of a valve caliber and a working pressure of a large-caliber magnetic valve known to inventors, a pressure difference force in an axial direction is increased accordingly, and a greater driving force is required to achieve the development.

As shown in FIG. 1, the large-caliber Magnetic valve in a technology known to inventors adopts a pilot-type structure, and is provided with a core iron assembly 1, a valve core 2, a return spring 3, a core iron spring 4 and the like. While energized, the core iron assembly 1 is separated from a small hole of the valve core 2, and a pressure difference force between inlet and outlet of the valve is released, thereby the valve core 2 achieves the valve opening under an action of the return spring 3. There are defects such as many parts and non-compact structures. In addition, the return spring 3 has an action relationship with a pressure difference force of a valve head and an elastic force of the core iron spring 4, so that the design is complicated, and the reliability is poor.

### SUMMARY

Some embodiments of the present disclosure provide a magnetic valve, as to solve problems of a magnetic valve known to inventors that the structure is complicated and the reliability is poor.

According to one aspect of the present disclosure, a magnetic valve is provided. The magnetic valve includes a valve body, a valve core, a core ion assembly, an attractor, and a balancing channel. The valve body is provided with an installation cavity, a first valve port and a second valve port, the first valve port and the second valve port are both communicated with the installation cavity. The valve core is installed in the installation cavity, the valve core has a valve opening position that allows the first valve port and the second valve port to be communicated and a valve closing position that allows a communication of the first valve port and the second valve port to be turned off, while the valve core is located in the valve closing position, the valve core divides the installation cavity into a first cavity located at a first end of the valve core, a second cavity located at an outer periphery of a main body of the valve core and a third cavity located at a second end of the valve core, the first valve port is communicated with the third cavity, and the second valve port is communicated with the second cavity. The core iron assembly is installed in the installation cavity, and the core iron assembly includes a core iron and an elastic element, the valve core is fixedly connected with a first end of the core iron. The attractor is installed in the installation cavity and located at a second end of the core iron, two ends of the elastic element are respectively pressed against the attractor and the core iron. The balancing channel is extended along an axial direction of the valve core and the core iron so that the first cavity and the third cavity are communicated.

In some embodiments, the valve core and the core iron are fixed together by threaded connection or by a welding or riveting mode.

In some embodiments, the core iron and/or the outer periphery of the valve core is provided with a through hole communicated with the first cavity.

In some embodiments, there is a plurality of through holes, and the plurality of the through holes is arranged at intervals along a circumferential direction of the valve core.

In some embodiments, the core iron is provided with a stepped hole, and a first end of the elastic element is pressed against a stepped surface of the stepped hole, and a second end of the elastic element is pressed against the attractor.

In some embodiments, the stepped hole is arranged coaxially with the balancing channel.

In some embodiments, between the outer periphery of the valve core and a side wall of the installation cavity, a sealing structure for separating the first cavity and the second cavity is arranged.

In some embodiments, the outer periphery of the valve core is provided with an annular groove, and the sealing structure includes a sealing ring arranged in the annular groove.

In some embodiments, while the first valve port is an inlet, the second valve port is an outlet, and while the second valve port is an inlet, the first valve port is an outlet.

In some embodiments, the balancing channel includes a first channel section and a second channel section, herein the first channel section is arranged on the core iron, the second channel section is arranged on the valve core, and the first channel section and the second channel section are butted and communicated to each other.

In some embodiments, the valve core and the core iron are fixed together to form a whole structure.

In some embodiments, the valve body includes a sleeve, and an outer periphery of the sleeve is provided with a coil structure.

Some embodiments of the present disclosure are applied, the magnetic valve in the present disclosure is a normally closed valve. While the coil structure is energized, under an attraction of the attractor, the core iron overcomes a spring force of the elastic element and a friction force received by the valve core to drive the valve core to move to one end close to the attractor, so that the first valve port and the second valve port are connected, and the magnetic valve is located in a valve opening position. In this process, because the valve core and the core iron of the magnetic valve in the present disclosure are provided with the balancing channel, while fluid enters the third cavity, it may quickly enter the first cavity from the balancing channel, so that a pressure difference between the two ends of the valve core is effectively balanced. While resetting, only if the magnetic valve is de-energized and the elastic element is reset, the valve core may be switched from the valve opening position to the valve closing position. Compared with the structure known to inventors, the magnetic valve in some embodiments of the present disclosure has a simpler structure, and structures such as a return spring dedicated to the valve core is omitted. At the same time, after the magnetic valve in the present disclosure uses the balancing channel to balance the pressure difference at the both ends of the valve core, a valve opening driving force of the magnetic valve may be reduced, the production costs of structural parts such as a coil for driving the magnetic valve to open may be saved, the working process of the magnetic valve is more stable and reliable, and the production difficulty of the magnetic valve is reduced.

### BRIEF DESCRIPTION OF THE DRAWINGS

Drawings of the description for constituting a part of the present disclosure are used to provide further understanding of the present disclosure, and exemplary embodiments of the present disclosure and descriptions thereof are used to explain the present disclosure, and do not constitute improper limitation to the present disclosure. In the drawings:

FIG. 1 schematically shows a cross-sectional view of a magnetic valve known to inventors.

FIG. 2 schematically shows a partially cut perspective view of a magnetic valve of the present disclosure while the valve is opened.

FIG. 3 schematically shows a partially cut perspective view of the magnetic valve of the present disclosure while the valve is closed.

FIG. 4 schematically shows a first cross-sectional view of the magnetic valve of the present disclosure while the valve is closed.

FIG. 5 schematically shows a second cross-sectional view of the magnetic valve of the present disclosure while the valve is closed.

Herein, the above drawings include the following reference signs:

10. Valve body, 11. Installation cavity, 111. First cavity, 112. Second cavity, 113. Third cavity, 12. First valve port, 13. Second valve port, 20. Valve core, 21. Annular groove, 22. Through hole, 30. Core iron assembly, 31. Core iron, 311. Stepped hole, 32. Elastic element, 40. Attractor, 50. Balancing channel, 51. First channel section, 52, Second channel section, and 60. Sealing structure.

### DETAILED DESCRIPTION OF THE EMBODIMENTS

It should be noted that embodiments in the present disclosure and features in the embodiments may be combined with each other in the case without conflicting. The present disclosure is described in detail below with reference to the drawings and in combination with the embodiments.

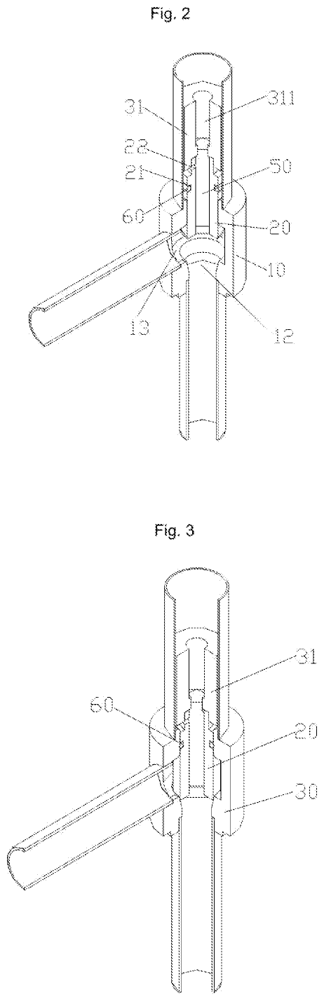

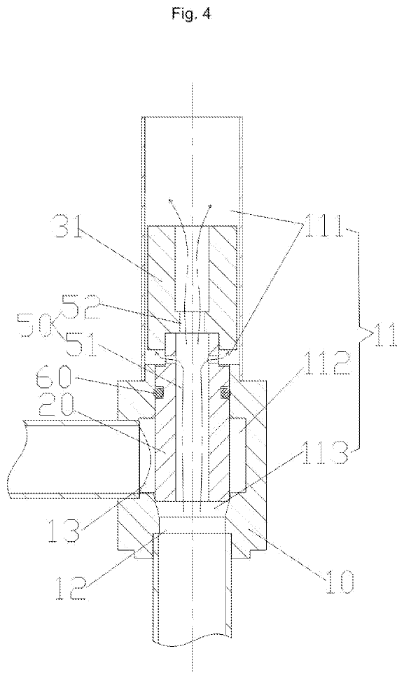

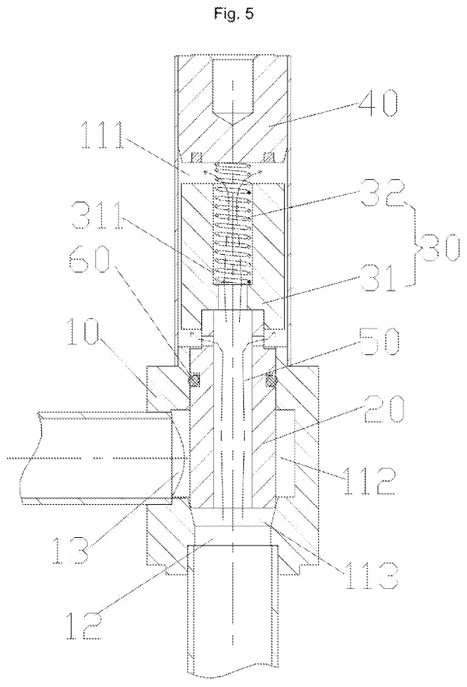

Refer to FIG. 2 to FIG. 5, according to some embodiments of the present disclosure, a magnetic valve is provided. The magnetic valve in this embodiment includes a valve body 10, a valve core 20, a core iron assembly 30, an attractor 40, a balancing channel 50 and a coil structure (unshown in the figure).

Herein, the valve body 10 is provided with an installation cavity 11, a first valve port 12 and a second valve port 13, the first valve port 12 and the second valve port 13 are both communicated with the installation cavity 11. The valve core 20 is installed in the installation cavity 11, the valve core 20 has a valve opening position that allows the first valve port 12 and the second valve port 13 to be communicated and a valve closing position that allows the communication of the first valve port 12 and the second valve port 13 to be turned off. Herein, while the valve core 20 is located in the valve closing position, the valve core 20 divides the installation cavity 11 into a first cavity 111 located at a first end of the valve core 20, a second cavity 112 located at an outer periphery of a main body of the valve core 20, and a third cavity 113 located at a second end of the valve core 20. In an actual design, the first valve port 12 is communicated with the third cavity 113, and the second valve port 13 is communicated with the second cavity 112. The core iron assembly 30 is installed in the installation cavity 11, the core iron assembly 30 includes a core iron 31 and an elastic element 32, and the valve core 20 is fixedly connected with a first end of the core iron 31. The attractor 40 is installed in the installation cavity 11 and located at a second end of the core iron 31, and both ends of the elastic element 32 are respectively pressed against the attractor 40 and the core iron 31. The balancing channel 50 is extended along an axial direction of the valve core 20 and the core iron 31 so that the first cavity 111 and the third cavity 11 are communicated. In some embodiments, the valve body 10 includes a sleeve, and the outer periphery of the sleeve is provided with the above coil structure.

The magnetic valve in some embodiments is a normally closed valve. While the coil structure is energized, under an attraction of the attractor 40, the core iron 31 overcomes a spring force of the elastic element 32 and a friction force received by the valve core 20 to drive the valve core 20 to move to one end close to the attractor 40, so that the first valve port 12 and the second valve port 13 are connected, and the magnetic valve is located in the valve opening position. In this process, because the valve core 20 and the core iron 31 of the magnetic valve in the present disclosure are provided with the balancing channel 50, while fluid enters the third cavity 113, it may quickly enter the first cavity 111 from the balancing channel 50, so that a pressure difference between the two ends of the valve core 20 is effectively balanced. While resetting, only if the magnetic valve is de-energized and the elastic element 32 is reset, the valve core 20 may be switched from the valve opening position to the valve closing position. Compared with the previous structure, the magnetic valve in the present disclosure has a simpler structure, and structures such as a return spring dedicated to the valve core 20 is omitted. At the same time, after the magnetic valve in some embodiments of the present disclosure uses the balancing channel 50 to balance the pressure difference at the both ends of the valve core 20, a valve opening driving force of the magnetic valve is reduced, production costs of structural parts such as a coil for driving the magnetic valve to open are saved, a working process of the magnetic valve is more stable and reliable, and a production difficulty of the magnetic valve is reduced.

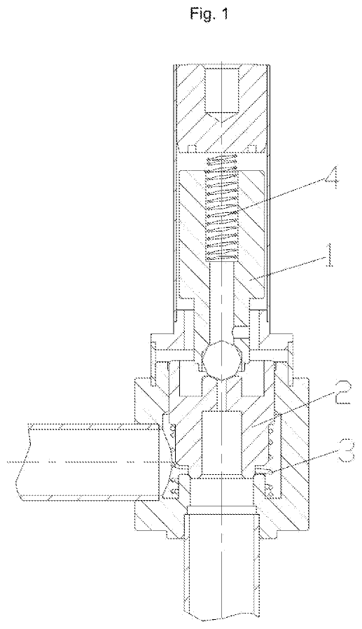

In actual use, the magnetic valve in this embodiment may be used bidirectionally. While the first valve port 12 is an inlet, the second valve port 13 is an outlet, and while the second valve port 13 is an inlet, the first valve port 12 is an outlet. Compared with the structure in FIG. 1, the magnetic valve in the embodiments may be used bidirectionally, and a case may not occur in the structure shown in FIG. 1 that while fluid with a larger pressure enters from the bottom of the magnetic valve, a return spring 3 may be rushed up. That is to say, the structure of the magnetic valve in the embodiments is more stable, may adapt to the fluid with a larger pressure variation range, and may adapt to more extreme working conditions.

In order to connect the valve core 20 and the core iron 31 together stably, in actual processing, the valve core 20 and the core iron 31 may be fixed together by threaded connection, or may be fixed together by a welding or riveting mode. Certainly, in other embodiments of the present disclosure, the valve core 20 and the core iron 31 may also be fixedly connected together by an injection molding mode and the like, or connected together by a connecting rivet and the like, as long as they are other deformation modes under the concept of the present disclosure, all fall within a scope of protection of the present disclosure.

In some embodiments, the balancing channel 50 includes a first channel section 51 and a second channel section 52, herein the first channel section 51 is arranged on the core iron 31, the second channel section 52 is arranged on the valve core 20, and the first channel section 51 and the second channel section 52 are in abutting communication, so that the first cavity 111 and the third cavity 113 located at the two ends of the valve core 20 are communicated, thereby a pressure difference between the two ends of the valve core 20 is balanced. In some embodiments, in order to enable the two ends of the valve core 20 to quickly reach a pressure difference balance, the core iron 31 and/or the outer periphery of the valve core 20 is provided with at least one through hole 22 communicated with the first cavity 111.

In some embodiments, there is a plurality of through holes 22, the plurality of the through holes 22 is arranged at intervals along a circumferential direction of the valve core 20, so that fluid is circulated in the third cavity 113 and the first cavity 111, thereby a purpose of quickly balancing the pressure difference is achieved.

Refer to FIG. 2 to FIG. 5 again, in some embodiments, the core iron 31 is provided with a stepped hole 311, a first end of the elastic element 32 is pressed against a stepped surface of the stepped hole 311, and a second end of the elastic element 32 is pressed against the attractor 40, the structure is simple, and it is convenient to limit a position of the elastic element 32.

In some embodiments, the elastic element 32 is a spring, the structure is simple, and the service life is long. Certainly, in other embodiments of the present disclosure, the elastic element 32 may also be configured as a structure such as an elastic column or an elastic rubber pad, as long as they are other deformation modes under the concept of the present disclosure, all fall within a scope of protection of the present disclosure.

In actual arrangement, the stepped hole 311 in some embodiments is arranged coaxially with the balancing channel 50. Certainly, in other embodiments of the present disclosure, the stepped hole 311 and the balancing channel 50 may also be arranged on different axes.

In some embodiments, in order to separate the first cavity 111 and the second cavity 112 while the magnetic valve is closed, prevent the magnetic valve from leaking, and achieve an effective valve closing function of the magnetic valve, between the outer periphery of the valve core 20 and a side wall of the installation cavity 11, a sealing structure for separating the first cavity 111 and the second cavity 112 is arranged.

Further, the outer periphery of the valve core 20 is provided with an annular groove 21, and the sealing structure 60 includes a sealing ring arranged in the annular groove 21, the structure is simple, and it is easy to implement.

It may be seen from the above embodiments, while the magnetic valve in this disclosure works, and while the valve is fully closed, three cavities are formed, namely the first cavity 111, the second cavity 112, and the third cavity 113. The first cavity 111 is composed of a space area formed by the sealing structure 60, the valve core 20, the core iron 31, the elastic element 32, the attractor 40, and the valve body 10. The second cavity 112 is composed of a space area formed by the second valve port 13, the sealing structure 60, the valve core 20 and the valve body 10. The third cavity 113 is composed of a space area formed by the valve core 20 and the first valve port 12. Due to the action of the balancing channel 50 and the sealing structure 60, the first cavity 111 is communicated with the third cavity 113, the pressure is balanced, and the first cavity 111 is isolated with the second cavity 112.

During a process of the valve core 20 from fully close to fully open, it is basically only affected by a friction force between the sealing structure 60 and the valve body 10, a return elastic force of the elastic element 32, and a self-weight effect of the valve core 20 (compared to a pressure difference force, the three may be basically ignored), a problem of the pressure difference force is solved fundamentally, the valve opening ability of a product is effectively improved, and a difficulty of product trial production is reduced.

While energized, an external coil magnetizes the attractor 40 and the core iron 31, both overcome a compression force of the elastic element 32, the friction force of the sealing structure 60 and the self-weight to be attracted axially, the valve opening is achieved. While de-energized, the core iron 31 and the valve core 20 achieve the valve closing under the action of a reset force of the elastic element 32. Due to the action of the balancing channel 50, a pressure balance of the valve core 20 in the various cavities of the valve body 10 may be guaranteed, and the valve opening ability of the product is improved.

In other embodiments of the present disclosure, the valve core 20 and the core iron 31 are fixed together to form a whole structure, so the production cost of the magnetic valve is effectively reduced.

It may be seen from the above descriptions that the above embodiments of the present disclosure achieve the following technical effects.

1. The magnetic valve of the present disclosure is simple in structure, and low in production cost.

2. The magnetic valve of the present disclosure may reduce a required load force, and may effectively improve the valve opening ability and service life of the product.

3. The magnetic valve may be used bidirectionally, and has a wider range of disclosure working conditions.

4. Due to an action of the balancing channel, a pressure of the magnetic valve core is balanced in each cavity, namely it is not affected by high working pressure and caliber, and may adapt to the more extreme working conditions.

The above are only some embodiments of the present disclosure, and are not intended to limit the present disclosure. For those skilled in the art, the present disclosure may have various modifications and changes. Any modifications, equivalent replacements, improvements and the like made within the spirit and principle of the present disclosure shall be included in the scope of protection of the present disclosure.

What is claimed is:

1. A magnetic valve, comprising:
a valve body, wherein the valve body is provided with an installation cavity, a first valve port and a second valve port, the first valve port and the second valve port are both communicated with the installation cavity;
a valve core, wherein the valve core is installed in the installation cavity, the valve core has a valve opening position that allows the first valve port and the second valve port to be communicated and a valve closing position that allows a communication of the first valve port and the second valve port to be turned off, while the valve core is located in the valve closing position, the valve core divides the installation cavity into a first cavity located at a first end of the valve core, a second cavity located at an outer periphery of a main body of the valve core and a third cavity located at a second end of the valve core, the first valve port is communicated with the third cavity, and the second valve port is communicated with the second cavity;
a core iron assembly, wherein the core iron assembly is installed in the installation cavity, and the core iron assembly comprises a core iron and an elastic element, the valve core is fixedly connected with a first end of the core iron;
an attractor, wherein the attractor is installed in the installation cavity and located at a second end of the core iron, two ends of the elastic element are respectively pressed against the attractor and the core iron; and
a balancing channel, wherein the balancing channel is extended along an axial direction of the valve core and the core iron so that the first cavity and the third cavity are communicated.

2. The magnetic valve according to claim 1, wherein the valve core and the core iron are fixed together by threaded connection or by a welding or riveting mode.

3. The magnetic valve according to claim 1, wherein
the core iron and the outer periphery of the valve core is provided with a through hole communicated with the first cavity; or
the core iron is provided with a through hole communicated with the first cavity; or
the outer periphery of the valve core is provided with a through hole communicated with the first cavity.

4. The magnetic valve according to claim 3, wherein there is a plurality of through holes, and the plurality of the through holes is arranged at intervals along a circumferential direction of the valve core.

5. The magnetic valve according to claim 1, wherein the core iron is provided with a stepped hole, and a first end of the elastic element is pressed against a stepped surface of the stepped hole, and a second end of the elastic element is pressed against the attractor.

6. The magnetic valve according to claim 5, wherein the stepped hole is arranged coaxially with the balancing channel.

7. The magnetic valve according to claim 1, wherein between the outer periphery of the valve core and a side wall of the installation cavity, a sealing structure for separating the first cavity and the second cavity is arranged.

8. The magnetic valve according to claim 7, wherein the outer periphery of the valve core is provided with an annular groove, and the sealing structure comprises a sealing ring arranged in the annular groove.

9. The magnetic valve according to claim 1, wherein while the first valve port is an inlet, the second valve port is an outlet, and while the second valve port is an inlet, the first valve port is an outlet.

10. The magnetic valve according to claim 1, wherein the balancing channel comprises a first channel section and a second channel section, wherein the first channel section is arranged on the core iron, the second channel section is arranged on the valve core, and the first channel section and the second channel section are butted and communicated to each other.

11. The magnetic valve according to claim 1, wherein the valve core and the core iron are fixed together to form a whole structure.

12. The magnetic valve according to claim 1, wherein the valve body comprises a sleeve, and an outer periphery of the sleeve is provided with a coil structure.

13. The magnetic valve according to claim 3, wherein the valve core and the core iron are fixed together to form a whole structure.

14. The magnetic valve according to claim 4, wherein the valve core and the core iron are fixed together to form a whole structure.

15. The magnetic valve according to claim 5, wherein the valve core and the core iron are fixed together to form a whole structure.

16. The magnetic valve according to claim 6, wherein the valve core and the core iron are fixed together to form a whole structure.

17. The magnetic valve according to claim 3, wherein the valve body comprises a sleeve, and an outer periphery of the sleeve is provided with a coil structure.

18. The magnetic valve according to claim 4, wherein the valve body comprises a sleeve, and an outer periphery of the sleeve is provided with a coil structure.

19. The magnetic valve according to claim 5, wherein the valve body comprises a sleeve, and an outer periphery of the sleeve is provided with a coil structure.

20. The magnetic valve according to claim 6, wherein the valve body comprises a sleeve, and an outer periphery of the sleeve is provided with a coil structure.
